(19) United States
(12) Patent Application Publication
(10) Pub. No.: US 2024/0075443 A1
(43) Pub. Date: Mar. 7, 2024

(54) GAS DISTRIBUTOR NOZZLE SYSTEM WITH SINTERED METAL FILTER MEDIA

(71) Applicant: SHELL OIL COMPANY, Houseton, TX (US)

(72) Inventors: Robert Alexander LUDOLPH, Houston, TX (US); Zhe CUI, Houseton, TX (US)

(21) Appl. No.: 18/261,868

(22) PCT Filed: Feb. 1, 2022
(86) PCT No.: PCT/US2022/014678

§ 371 Date: Jul. 18, 2023

Related U.S. Application Data
(60) Provisional application No. 63/146,415, filed on Feb. 5, 2021.

(51) Int. Cl. B01J 8/18; B01J 29/90; B01J 38/30

(52) U.S. Cl. CPC B01J 8/1818; B01J 29/90; B01J 38/30; B01J 2208/00902

(57) ABSTRACT

The invention provides a gas distribution system comprising a plurality of flow passages in fluid communication with a gas source, each flow passage having disposed therein a number of nozzles, wherein at least a portion of said nozzles are fitted with a sintered metal filter.

### FIELD OF THE INVENTION

This invention relates to an improved gas distribution system and its use in one or more fluidised bed systems, particularly within a fluidised catalytic cracking (FCC) process.

### BACKGROUND OF THE INVENTION

Many industrial processes include fluidised catalyst bed systems. For example, fluid catalytic cracking (FCC) processes are known processes used for the conversion of heavy hydrocarbon feedstock such as heavy crude oil distillate to lower molecular weight hydrocarbon products such as gasoline and middle distillate. An FCC process system typically includes a riser reactor, a stripper and a regenerator. A heavy hydrocarbon feedstock is introduced into the riser reactor wherein it is contacted with hot catalytic cracking catalyst particles from the regenerator. The mixture of the heavy hydrocarbon feedstock and catalytic cracking catalyst particles passes through the riser reactor wherein the cracked product is separated from the spent catalyst at the riser end. The separated cracked product passes to a downstream fractionation system and the spent catalyst passes through a stripping section, then to the regenerator where the coke deposited on the spent catalyst during the cracking reaction is burned off, via reaction with oxygen-containing gas, to regenerate the spent catalyst. The resulting regenerated catalyst is used as the aforementioned hot catalytic cracking catalyst particles and is mixed with the heavy hydrocarbon feedstock that is introduced into the riser reactor.

A number of regenerator and stripper concepts are described in the art, such as those in US20030143126, 035198397, GB769818 and WO2007076317. In most regenerators, the spent catalyst is provided to a regenerator vessel above a gas distribution system. Fast flowing oxygen-containing gas, usually air, is provided through the gas distribution system and fluidises the spent catalyst. A similar system operates in a stripper wherein steam is provided through the gas distribution system. Other gas distributors may be located within a system used within the FCC process for example steam or air distributors may be present at the entry to or along standpipes, in liftpot/wye/J-bend sections or in stagnant regions of process vessels.

In each case, in order to achieve consistent flow conditions, the gas distribution system needs to provide a consistent, radially uniform flow across the cross section of the vessels, for example regenerator vessel, stripper or standpipe. The vessels are generally cylindrical in shape and the gas distribution system generally comprises a distribution grid, having, for example, pipes with lateral conduits extending therefrom, pipes with nozzles, manifold systems, and fluid distribution rings. For example the gas distribution system may comprise one or multiple fluidization gas rings or grids, comprising conduits or pipes provided with nozzles or apertures.

From time to time, incidents may occur that temporarily suspend operation of the system, such as the regenerator or stripper, e.g. a power outage may occur. During such incidents, gas flow is interrupted and the fluidised flow ceases. Gravity has its inevitable effect and fluidised catalyst particles settle at the bottom of the vessel, including backflowing into the nozzles and gas distribution system.

Upon restart, in order to ensure even flow throughout the vessel, e.g. the regenerator or stripper, any catalyst particles within the gas distribution system will need to be blown back out into said vessel. It is challenging to ensure that all catalyst particles are blown back into the vessel. Any remaining in the gas distribution system may cause blockages and prevent an even distribution of the air, disrupting the flow within the vessel. In a gas distribution system used in a stripper, the problem of blockages may be exacerbated due to the potential presence of condensed water from the steam used therein.

Further, catalyst particles within the gas distribution system may cause erosion when blown within that system, leading to scouring of internals and erosion of equipment surfaces. This can damage the nozzles, alter the pressure drop and affect the flow within the system.

Nozzles within a typical gas distribution system are designed with sufficient pressure drop to support uniform radial flow. Single stage nozzles provide a simple design but undergo significant erosion over an operating cycle. In light of this, in a conventional system, a two-stage nozzle is used. Gas from a header enters a nozzle and passes through a narrow orifice, e.g. a circular orifice with a smaller diameter, before passing through a wider orifice, e.g. a circular orifice with a larger diameter, providing the critical pressure drop and minimising catalyst ingress.

Unfortunately, even a two-stage nozzle cannot prevent all catalyst ingress into a gas distribution system. It would, therefore, be highly desirable to provide a gas distribution system in which catalyst ingress is more fully avoided, preventing erosion and blockages, while maintaining critical pressure drop and uniform radial flow across a catalyst regenerator or stripper vessel.

### SUMMARY OF THE INVENTION

The present invention provides a gas distribution system comprising a plurality of flow passages in fluid communication with a gas source, each flow passage having disposed therein a number of nozzles, wherein at least a portion of said nozzles are fitted with a sintered metal filter.

### BRIEF DESCRIPTION OF THE DRAWINGS

FIG. 1 depicts a cross section of a regenerator vessel.

FIG. 2 illustrates an alternative arrangement of flow passages within a regenerator vessel.

FIG. 3 shows a typical two stage nozzle.

FIGS. 4a, 4b, 4c, 5 and 6 illustrate nozzles fitted with sintered metal filters according to the present invention.

### DETAILED DESCRIPTION OF THE INVENTION

The present invention relates to an improved gas distribution system suitable for use in fluidised catalyst bed systems, for example those within an FCC process such as a catalyst regenerator or stripper vessel.

The gas distribution system comprises a plurality of flow passages in fluid communication with a gas source. Any structure capable of distributing a gas source, for example air, uniformly across the cross section of the regenerator vessel is suitable for the structure of the flow channels. For example, pipes with lateral conduits extending therefrom, manifold systems and fluid distribution rings may all be suitable. In some embodiments, the gas source may include steam, inert gases, or oxidants.

The flow passages may be circular in cross-section, but other cross-sectional shapes, including, but not limited to, elliptical, oval, triangular, rectangular, hexagonal, octagonal, other polygonal shapes, or any combination thereof, may also be used. References made herein to diameters are understood to be an equivalent diameter, e.g., an average cross-sectional length, in those embodiments using non-circular flow passages.

The flow passages can contain a gas having a velocity from a low of about 0.1 m/s, about 1 about 3 m/s, about 10 m/s, or about 20 m/s to a high of about 40 m/s, about 60 m/s, about 80 m/s, about 90 m/s, or about 125 m/s. The gas within the flow passage can be at a pressure from a low of about 7 kPa, about 50 kPa, about 100 kPa, about 200 kPa, or about 300 kPa to a high of about 500 kPa, about 700 kPa, about 800 kPa, about 900 kPa, or about 1,500 kPa.

The nozzles have an inlet end in fluid communication with the flow passage and an outlet end positioned on the outside of the gas distribution system. The nozzles have a longitudinal axis that is substantially perpendicular to a direction of flow through the flow passage. The nozzle body may have an orifice positioned between the inlet end and the outlet end.

The nozzles can be sized and configured so as to create a pressure drop from a low of about 0.1 kPa, about 1 kPa, about 5 kPa, about 10 kPa, or about 20 kPa to a high of about 30 kPa, about 40 kPa, about 50 kPa, about 60 kPa, or about 70 kPa. The nozzles can also cause an outlet velocity profile from a low of about 0.5 m/s, about 4 m/s, about 8 m/s, about 15 m/s, or about 25 m/s to a high of about 50 m/s, about 70 m/s, about 90 m/s, about 95 m/s, or about 125 m/s.

At least a portion of the nozzles are fitted with a sintered metal filter.

The sintered metal filters are provided to enable high efficiency and reliability during operation.

It is intended that the sintered metal filter fills the entire cross section of the nozzles in which they are fitted. In certain embodiments, the filter has a cylindrical or tube-like shape. In other embodiments, the filter is shaped like a cup.

In at least some embodiments, the sintered metal filters are made from metal fibre media wherein at least portion of the individual metal fibres that make up the media have a shape with some three-dimensionality, which allows for a low packing density and high porosity filtration media. For example, when poured, the fibres can have a packing density as low as about 2-3%. The term “three-dimensional aspect” or “three-dimensionality” as used herein with respect to the shape of a metal fibre refers to random directional changes in the major axis of the fibre compared to a theoretical straight fibre, e.g., leading to a curved, kinked, entangled, cork screw, lazy curve, z-shape, 90 degree bend, or pigtail shape. When the fibres having a shape with some three-dimensionality are laid down or poured, they tend to interlock, resulting in a media having a fluffy texture, with a substantial amount of open space between the individual fibres. In certain embodiments, at least about 5%, at least about 10%, at least about 20%, at least about 30%, at least about 40%, at least about 50%, at least about 60%, at least about 75%, or at least about 90% of the individual metal fibres have a shape with a three-dimensional aspect. The percentage of fibres in the media having a shape with some three-dimensionality is determined, for example, by examining a representative number of fibres under a microscope.

In some embodiments, the fibres are short metal fibres including curved and entangled fibres. Such fibres are commercially available (e.g., from N.V. Bekaert S.A., Belgium). An example of such fibres, and methods for their preparation are described in U.S. Pat. No. 7,045,219 (Los fold et al.). As a brief summary, U.S. Pat. No. 7,045,219 discloses a set of short metal fibres including “entangled” fibres and “curved” fibres, e.g., having an equivalent diameter between 1 and 150 microns. The entangled fibres may represent 5 to 35% of the fibres and have an average length at least 5 times the average length of the curved fibres. The curved fibres may have an average length between 10 and 2000 microns, and a portion of the curved fibres may have a major axis that changes over an angle of at least 90 degrees. The length/diameter ratio of the entire set of fibres may be more than 5. The entangled fibres are entangled within themselves or with each other, and the major axis of each entangled fibre changes often and unpredictably. Some of the fibres have a chaotic shape, look like a pigtail, or are present in a shape that resembles a clew. When poured, the fibres may have an apparent density in the range of 20 to 40%. The short metal fibres can be obtained by individualizing metal fibres in a carding operation, cutting or entangling and sieving the fibres, using a comminuting machine.

As a result of their shapes, the fibres employed according to various embodiments herein tend to have a low packing density. Thus, for a given volume of fibres, a significant portion of the volume is empty or ambient space, i.e., the porosity tends to be high. This low packing density/high porosity allows the filters made from such fibres to exhibit a low pressure drop as fluid flows through the filter.

Useful materials for making the fibres of some embodiments include, but are not limited to, one or more of stainless steel, including 316L stainless steel, nickel, thallium, titanium, aluminium, tungsten, copper, metal oxides and alloys, such as Hastelloys, bronze, Cu-alloys, and Fe—Cr—Al alloys.

Exemplary dimensions for the fibres used according to various embodiments include fibre equivalent diameters of about 1 micron to about 150 microns, for example, about 1 micron to about 75 microns, about 1 micron to about 50 microns, about 1 micron to about 35 microns, or about 1 micron to about 10 microns; and fibre lengths of about 10 microns to about 2000 microns, for example, about 10 microns to about 1000 microns, about 10 microns to about 200 microns, or about 10 microns to about 100 microns. The “equivalent diameter” of a fibre refers to the diameter of a circle having the same cross-sectional area as the fibre cut perpendicular to its major axis. The length of a fibre refers to the distance along its major axis if the fibre were straightened out such that there is no change in the major axis of the fibre.

Any suitable method of making a filter or filter media from such fibres may be applied to produce the filters to be fitted to the nozzles, for example moulding by axial pressing or by isostatic pressing.

In the gas distribution system of the present invention, at least a portion of nozzles are fitted with a sintered metal filter. It is preferred that the majority (more than 50%) of nozzles are fitted with a sintered metal filter. More preferably, at least 60%, even more preferably at least 70%, even more preferably at least 80%, even more preferably at least 90%, even more preferably at least 95%, even more preferably at least 98%, even more preferably at least 99% of the nozzles are fitted with a metal filter. In a most preferred embodiment, substantially all of the nozzles in the gas distribution system are fitted with a metal filter.

The gas distribution system of the present invention is suitably disposed in a vessel containing a bed of solid particles and is used to distribute gas in the vessel to fluidise the bed of solid particles.

In such a system, it is important to maintain a constant pressure drop across all of the nozzles in the system. This ensures an even flow of gas across the entire vessel. This is typically achieved by controlling the orifice sizes in a two stage nozzle, but may advantageously be achieved in the present invention by controlling the pore size and thickness of the filters fitted to the nozzles.

One exemplary, but non-limiting, use of gas distribution systems as described herein can be in the stripping and/or regeneration of catalyst used in a fluid catalytic cracking (FCC) process. The FCC process utilizes solid catalysts to facilitate the cracking of heavy hydrocarbon streams to produce lighter hydrocarbon products. As a by-product of cracking, a carbonaceous coke can be deposited on the catalyst, which can lead to deactivation of the catalyst. The coke can be removed from the catalyst by a combustion process, known as catalyst regeneration.

In such an embodiment wherein the gas distribution system is used in a catalyst regenerator in a fluid catalytic cracking process, the gas source comprises one or more oxidants. As used herein, an “oxidant” can refer to any compound or element suitable for oxidizing the coke on the surface of the catalyst. Such oxidants include, but are not limited to ambient air having an oxygen concentration of approximately 21 vol %, oxygen enriched air (air having an oxygen concentration greater than ambient air), oxygen, oxygen deficient air (air having an oxygen concentration less than ambient air), or any combination or mixture thereof.

### DETAILED DESCRIPTION OF THE DRAWINGS

The present invention is further described by reference to the exemplary and non-limiting drawings.

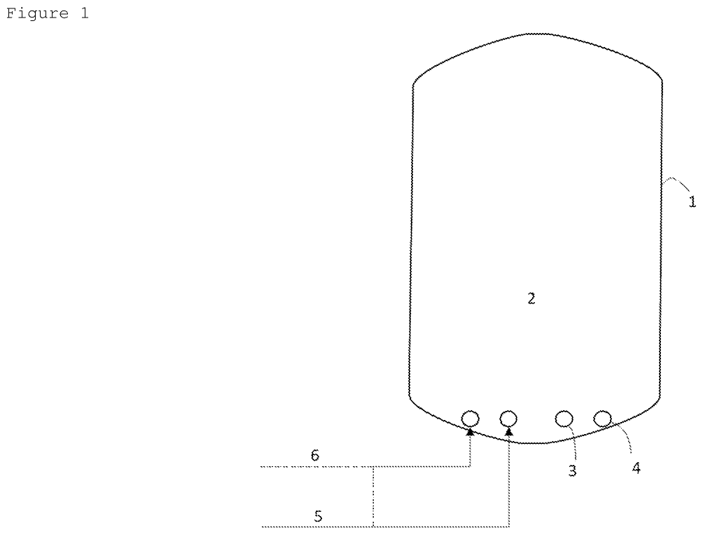

FIG. 1 represents a cross section of a regenerator vessel 1 containing a fluidised bed 2. Positioned at the lower end of the regenerator vessel 1 is a gas distribution system. Said gas distribution system comprises a plurality of flow passages (3 and 4) in fluid communication with a gas source (5 and/or 6). In this exemplary embodiment the plurality of flow passages is represented by two flow passages 3 and 4 in the form of concentric circles. It would be readily understood that a different number of flow passages may also be used, or that a different arrangement of flow passages may be suitable.

In one embodiment of the invention, the plurality of flow passages (3 and 4) are connected and supplied by a single gas source 5. In another embodiment of the invention, the flow passages within the regenerator vessel may be supplied by two or more gas sources 5 and 6, optionally at different pressures or flow rates, to allow for precise control of the flow of gas across the reactor.

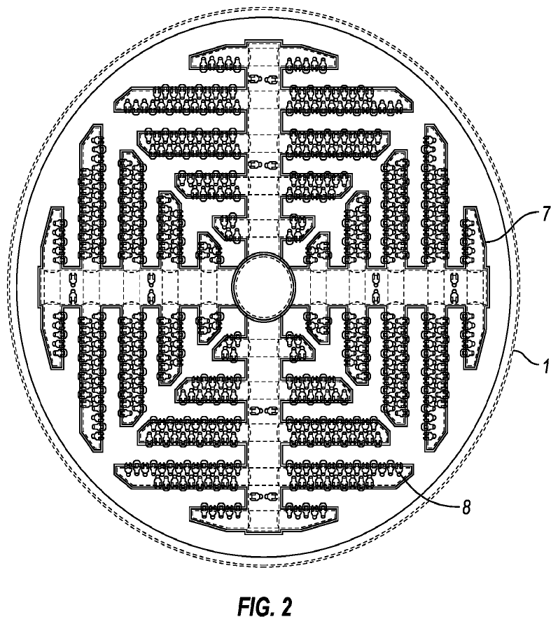

FIG. 2 illustrates a different arrangement of flow passages 7 within a regenerator vessel 1. In FIG. 2 a plurality of nozzles 8 can be seen to be disposed within each flow passage. The nozzles 8 are angled downwards with respect to the regenerator. In the inventive gas distribution system at least a portion of said nozzles are fitted with a sintered metal filter.

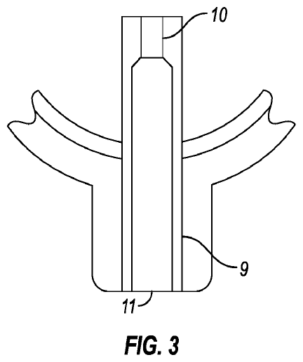

FIG. 3 shows a typical two stage nozzle 9. In such a nozzle, the diameter of the internal opening 10 is smaller than that of the external opening 11.

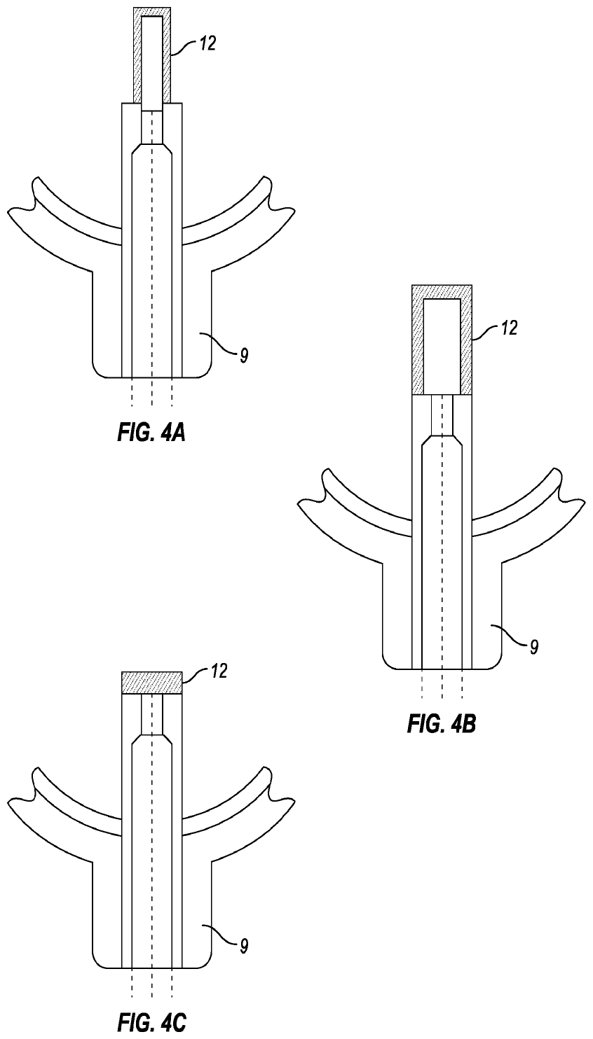

FIGS. 4a, 4b and 4c, show embodiments of nozzles 9 fitted with sintered metal filters 12 according to the present invention. In FIGS. 4a and 4b, cup shaped filters are fitted over two stage nozzles. An example of a cylindrical disc filter is shown in FIG. 4c. These filters provide the protection from catalyst backing up into the distributor. The filter thickness and pore size will determine how much protection there is and how much flow can pass through the nozzle

The diameter of the first stage orifice may need to be increased to compensate for the pressure drop brought by the filter so as to preserve the overall pressure drop of the nozzle.

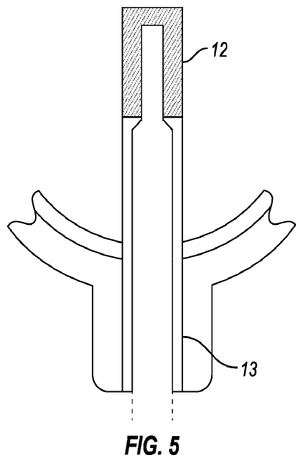

An alternative embodiment is shown in FIG. 5, where a single stage nozzle 13 is fitted with a sintered metal filter 12. In this Figure, a cup shaped filter is illustrated, but a cylindrical disc shaped filter may also be suitable.

In the embodiment of FIG. 5, the sintered metal filter provides the pressure drop instead of the 1st stage orifice. The filter thickness and pore size will determine how much protection there is and how much flow can pass through the nozzle. This embodiment has the added advantage that the nozzle may be fabricated as a tube with a single constant diameter, reducing cost. The filter may then be attached, for example by welding or screwing into place. The filter is selected to provide the desired pressure drop as well as protection from catalyst backing up into the distributor.

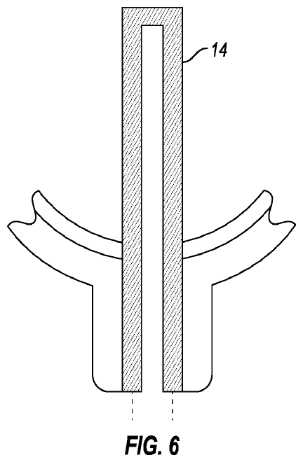

A further possible embodiment of the invention is illustrated in FIG. 6 in which the entire nozzle is constructed of the sintered metal filter material 14. Such an embodiment enjoys even simpler construction as the entire nozzle with sintered metal filter is constructed as one element.

1. A gas distribution system comprising a plurality of flow passages in fluid communication with a gas source, each flow passage having disposed therein a number of nozzles, wherein at least a portion of said nozzles are fitted with a sintered metal filter.

2. A system as claimed in claim 1, wherein substantially all of the nozzles in the gas distribution system are fitted with a metal filter.

3. A system as claimed in claim 2, wherein the sintered metal filters are fitted across the entire cross section of the nozzles to which they are fitted.

4. A system as claimed in claim 1, wherein the sintered metal filters are fitted over two stage nozzles.

5. A system as claimed in claim 1, wherein the sintered metal filters are fitted onto single stage nozzle.

6. A system as claimed claim 1, wherein the entire nozzle is constructed of the sintered metal filter material.

7. A system as claimed claim 1, wherein the gas distribution system is disposed in a vessel containing a bed of solid particles and used to distribute gas in the vessel to fluidise the bed of solid particles.

8. A system as claimed in claim 1, wherein the gas distribution system is used in a catalyst regenerator in a fluid catalytic cracking process.

9. A system as claimed claim 1, wherein the gas distribution system is used in a catalyst stripper in a fluid catalytic cracking process.

10. A system as claimed in claim 8, wherein, the gas source comprises one or more oxidants selected from oxygen enriched air, oxygen, nitrogen enriched air, or any combination or mixture thereof.
